(19) United States
(12) Patent Application Publication
(10) Pub. No.: US 2024/0119489 A1
(43) Pub. Date: Apr. 11, 2024

(54) PRODUCT SCORE UNIQUE TO USER

(71) Applicant: Albert Pizzinini, Cornedo Vicentino (IT)

(72) Inventor: Albert Pizzinini, Cornedo Vicentino (IT)

(21) Appl. No.: 17/961,100

(22) Filed: Oct. 6, 2022

(51) Int. Cl. G06Q 30/02; G06F 16/903

(52) U.S. Cl. CPC G06Q 30/0282; G06F 16/903

(57) ABSTRACT

One embodiment provides a method, the method including: receiving, at a product scoring software application, user input identifying at least one characteristic corresponding to a user; obtaining, at the product scoring software application, data for at least one product viewable by the user, wherein the data includes at least one ingredient of the at least one product; correlating, using the product scoring software application, the at least one ingredient to a rating of the at least one ingredient, wherein the rating is selected in view of the at least one characteristic corresponding to the user; and generating, using the product recommendation software application, a product score for the at least one product in view of the correlating and unique to the user. Other aspects are described and claimed.

### BACKGROUND

When a user is shopping for a product, the user may have different product characteristics in mind. For example, when the user is shopping for a healthcare or beauty product, the user may have specific conditions (e.g., health conditions, regional conditions, etc.) or areas of focus that they want the product to correct or address. Many products can have many different ingredients that generally work together to perform one or more intended functions. Some of the ingredients are usually directed to addressing one condition, while other ingredients may be directed to addressing another condition. In addition to addressing areas of focus for the user, the user may also have other criteria, like user preferences, to take into account when selecting a product, for example, scents, flavors, product delivery type, dietary restrictions, and/or the like.

### BRIEF SUMMARY

In summary, one aspect provides a method, the method including: receiving, at a product scoring software application, user input identifying at least one characteristic corresponding to a user; obtaining, at the product scoring software application, data for at least one product viewable by the user, wherein the data includes at least one ingredient of the at least one product; correlating, using the product scoring software application, the at least one ingredient to a rating of the at least one ingredient, wherein the rating is selected in view of the at least one characteristic corresponding to the user; and generating, using the product recommendation software application, a product score for the at least one product in view of the correlating and unique to the user.

Another aspect provides a system, the system including: a processor; a memory device that stores instructions that, when executed by the processor, causes the information handling device to: receive, at a product scoring software application, user input identifying at least one characteristic corresponding to a user; obtain, at the product scoring software application, data for at least one product viewable by the user, wherein the data includes at least one ingredient of the at least one product; correlate, using the product scoring software application, the at least one ingredient to a rating of the at least one ingredient, wherein the rating is selected in view of the at least one characteristic corresponding to the user; and generate, using the product recommendation software application, a product score for the at least one product in view of the correlating and unique to the user.

A further aspect provides a product, the product including: a computer-readable storage device that stores executable code that, when executed by a processor, causes the product to: receive, at a product scoring software application, user input identifying at least one characteristic corresponding to a user; obtain, at the product scoring software application, data for at least one product viewable by the user, wherein the data includes at least one ingredient of the at least one product; correlate, using the product scoring software application, the at least one ingredient to a rating of the at least one ingredient, wherein the rating is selected in view of the at least one characteristic corresponding to the user; and generate, using the product recommendation software application, a product score for the at least one product in view of the correlating and unique to the user.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method for generating a product score for a product based upon ingredients within the product and ratings for those ingredients where the ratings are based upon characteristics of the user.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Generally, many different products can claim to fulfill the requirements or desires of the user. Thus, selecting an appropriate product can become difficult and time-consuming. Additionally, many different ingredients may address the same issue or condition, but may not all be successful for every user. Some ingredients may also be affected by environmental or other factors that are not directly related to a particular characteristic of the user. For example, humidity, water quality, temperature, and/or other environmental characteristics can cause some ingredients to work contrary to the expected outcome. Accordingly, a user may frequently end up with products that do not work for the user or that the user simply does not like.

Generally, when a user is attempting to find a new product, the user may ask a salesperson for a recommendation regarding a product that may address the desires of the user. However, salespeople may not be highly educated on different ingredients, particularly in view of different characteristics of a user, for example, skin type, allergies, desired outcomes, and/or the like. Additionally, if the user is shopping for a product online, the user has to go through hundreds of reviews in order to reasonable suggestions. In this case, the user can provide search and filtering criteria to attempt to find a product that will work for the user. The user may also provide a condition that the user wants to correct or address with a particular product. However, provision of a condition only takes into account the specific condition and does not take into account other characteristics of the user, including environmental and other factors that may affect the function of the product.

The user may also rely on ratings or reviews by other users. However, these ratings and reviews are hard to correlate to the user because either the user does not know anything about the person providing the ratings and reviews and whether that person may have similar characteristics to the user or the information provided about the person providing the ratings are insufficient to understand whether the person may have similar characteristics to the user. Thus, even with reviews and ratings, the user does not know if the product will work or perform as desired until the user buys the product and uses it. This frequently results in a user having many different products that do not work or perform as the user wanted and therefore, results in wasted product, wasted money, lost time, and aggravation for the user.

Accordingly, the described system and method provides a technique for generating a product score for a product based upon ingredients within the product and ratings for those ingredients where the ratings are based upon characteristics of the user. The system provides a product scoring software application that a user can access to find products. The user can provide user input identifying at least one characteristic corresponding to the user. The characteristic may be a direct characteristic of the user, for example, gender, skin type, age, eye color, blood factors, and/or the like. The characteristics may also be indirect characteristics that are related to the user and that may affect the function of a product, but are not characteristics of the user themselves, for example, environmental factors, geographic location, time of year, and/or the like.

The product scoring system may, via the application, obtain data for at least one product that is viewable by the user. Viewable by the user means that the user can see the product, whether the user could view the product directly, for example, in a store, a person's home, etc.; could view the product virtually, for example, on the product page, within the product scoring software application, on a social media page, on the metaverse, etc.; and/or the like. Viewable does not mean that the user has to be directly looking at the product or the product thumbnail or webpage. Rather, viewable means that the product is within the field of vision of the user.

The data may identify one or more ingredients of the product. Identification of the ingredients may require the system to access a database or other data store to identify the ingredients. Thus, the data may include information that allows the system to identify the ingredients, for example, a name of the product, a manufacturer of the product, a distributor of the product, a barcode, and/or other information that can be used to identify the product and/or ingredients of the product.

The system then correlates the ingredients to ratings of ingredients. The ratings used for the correlation are selected in view of the characteristic of the user. For example, the ratings may be provided by the user themselves, thereby making the ratings based upon the characteristics of the user since the user provided the ratings. The user may provide ratings regarding other products that may have the same ingredient. As another example, the ratings may be provided by other users who have similar or the same characteristics as the user. Other users may not have to have all the same characteristics. Rather, the other users may have the same characteristic that is of interest or that affects the function or effectiveness of the product. The correlation effectively provides a rating of a single ingredient through extrapolation of ratings of products. From the correlation, the system generates a product score for the at least one product that is based upon the ingredients in the product and that is unique to the user due to the fact the correlation is made in view of ratings provided by the user or based upon characteristics of the user.

The described system represents a technical improvement over current techniques for selecting a product for the user. Instead of the user having to buy a product and hope that it works as the user desires, the described system and method provides a more directed technique for selecting products for the user. Since the system is able to identify ratings for specific ingredients within a product, the system can perform a more detailed analysis on products to identify those products that will work as the user wants. Additionally, since the ratings are identified in view of characteristics of the user, the product score is unique to the user and based upon a history of the user, instead of simply based upon desired outcomes of the user as with traditional techniques. The fact that the system generates the product score in view of ratings for specific ingredients and the characteristics of the user adds an additional layer in the product score as compared to traditional techniques which may allow a user to identify a particular condition to address. Thus, the described system and method provides a technique that allows a user to select a product that performs as intended more quickly than traditional techniques, thereby resulting in less product waste, wasted money, time spent searching for a product, and aggravation.

The illustrated example embodiments will be best understood by reference to the figures. The following description is intended only by way of example, and simply illustrates certain example embodiments.

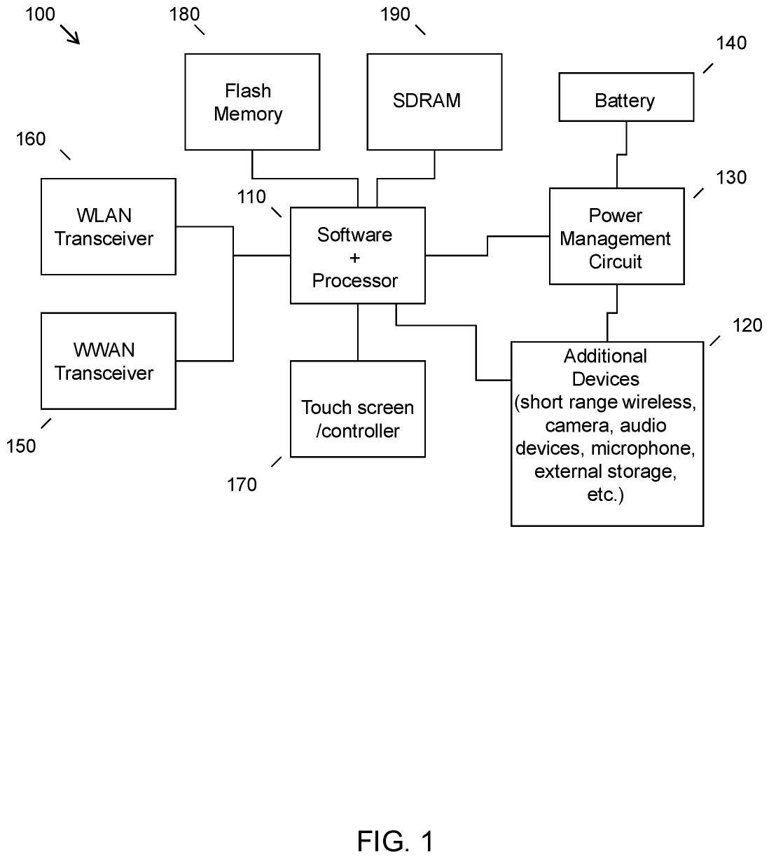

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks, such as telecommunications networks and wireless Internet devices, e.g., access points. Additionally, devices 120 are commonly included, e.g., a wireless communication device, external storage, etc. System 100 often includes a touch screen 170 for data input and display/rendering. System 100 also typically includes various memory devices, for example flash memory 180 and synchronous dynamic random-access memory (SDRAM) 190.

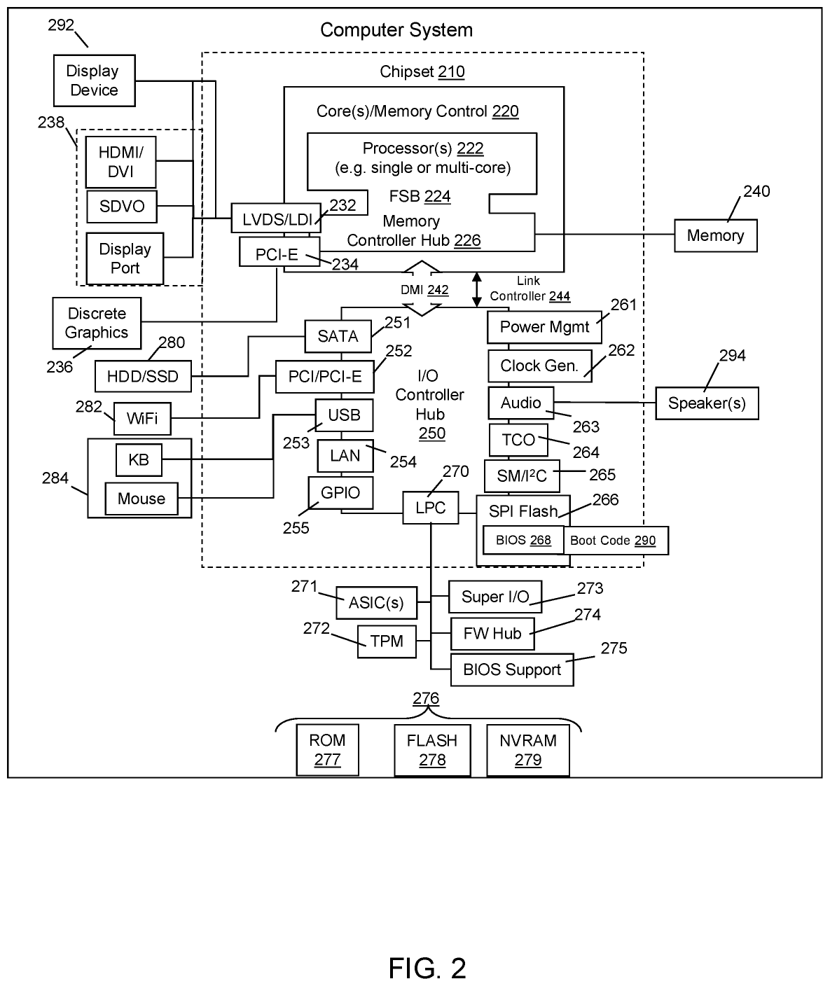

FIG. 2 depicts a block diagram of another example of information handling device circuits, circuitry or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may be utilized in a job search system, for example, to perform the job filtering, receiving user input, displaying output based upon user input, and/or the like. For example, the circuitry outlined in FIG. 1 may be implemented in a tablet or smart phone embodiment, whereas the circuitry outlined in FIG. 2 may be implemented in a personal computer embodiment.

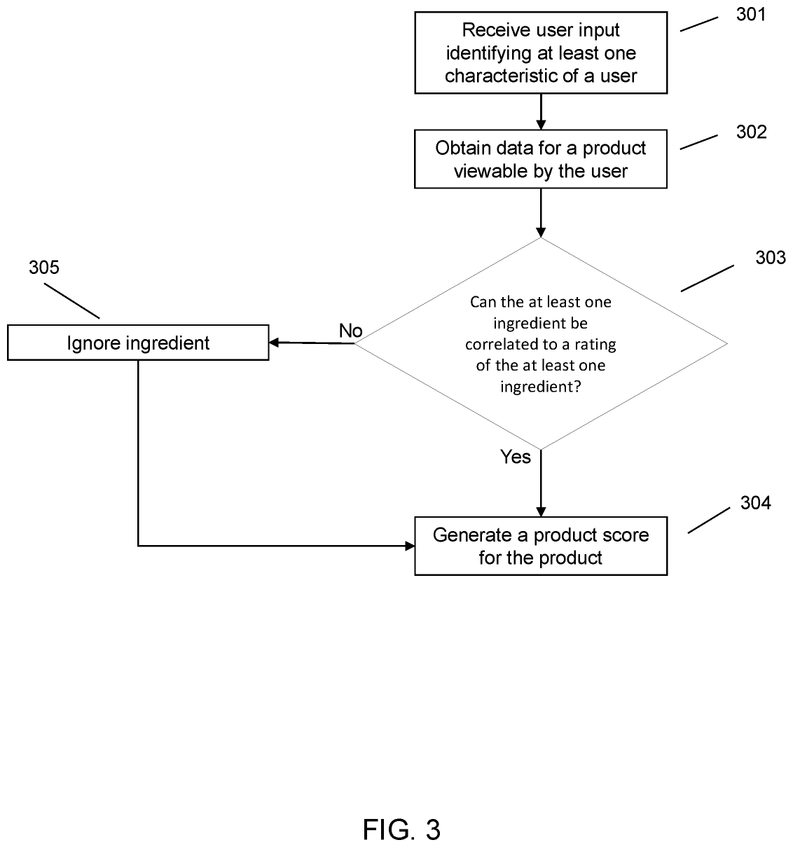

FIG. 3 illustrates an example method for generating a product score for a product based upon ingredients within the product and ratings for those ingredients where the ratings are based upon characteristics of the user. The method may be implemented on a system which includes a processor, memory device, output devices (e.g., display device, printer, etc.), input devices (e.g., keyboard, touch screen, mouse, microphones, sensors, biometric scanners, etc.), image capture devices, and/or other components, for example, those discussed in connection with FIG. 1 and/or FIG. 2. While the system may include known hardware and software components and/or hardware and software components developed in the future, the product scoring system itself is specifically programmed to perform the functions as described herein to generate a product score for a product. Additionally, the product scoring system, hardware components, and system includes modules, features, and a software application that are unique to the described system.

The product scoring system provides a software application that includes a graphical user interface that allows for user input and that provides output to the user. The user can access the software application and provide inputs. Accordingly, the graphical user interface of the software application provides input fields that can receive user input. The input fields may be provided within a single graphical user interface display or may be provided in secondary displays, for example, pop-up windows, secondary tabs, and/or the like. The graphical user interface may also provide other areas that the user can provide input into, for example, icons, menus, selection areas, free-form text boxes, and/or the like. The graphical user interface may also have display areas, for example, non-selectable icons, displays, graphics, logos, and/or the like.

The graphical user interface may have different formats and/or layouts, for example, single pages that move to other pages as a user interfaces with the application, scrollable pages, and/or the like. The formats may also vary between different information handling devices and/or application type, for example, a different format for a smart phone as compared to the format for a laptop computer, a different format for a mobile application as compared to an Internet-based application, and/or the like.

The software application may populate products by mining the products from secondary sources, for example, Internet searches, websites associated with such types of products, social media sites, and/or the like. Products may also be manually uploaded to the software application. Manufacturers, distributors, and/or other providers of products may also upload or provide products to the software application. The provider of the software application may also provide customizable products that can be accessed or created using the software application.

The described system could be accessed or implemented in a number of different forms. For example, the product scoring software application may be accessible and viewable within an Internet browser, stand-alone application, and/or the like. In such an implementation, the user can access the graphical user interface of the product scoring software application on a display screen, monitor, or other viewing device of an information handling device (e.g., smart phone, laptop computer, personal computer, tablet, smart watch, smart television, smart appliance, etc.). The graphical user interface may display products, product scores, and/or the like.

As another example, the software application could be integrated into or accessible through an augmented or virtual reality headset. In such an implementation, the user may enter a store and view products. On the augmented display, the system may display virtual objects, for example, the product scores, product information, and/or the like, next to or near the location of the real object (i.e., the product) on the augmented display. In other words, the augmented display may make it appear that the product score or other virtual object is within proximity to the real product.

The example that will be used here throughout for ease of readability is the example of healthcare or beauty products and, specifically, skin care products. However, this is merely an example and is not intended to limit the scope of this disclosure. The described system and method can be utilized in many different applications that include products having ingredients, for example, perfumes, makeup, skin care, hair care, over-the-counter medications, supplements, edible skin care, teeth care, deodorants/anti-perspirants, food products, and/or the like.

At 301, the product scoring software application may receive user input identifying at least one characteristic corresponding to the user. Characteristics may include any information about the user that can influence the function of a particular product for a user. Thus, the characteristics may include direct user characteristics that identify features of the user themselves. Examples of direct user characteristics include, but are not limited to, eye color, skin type, hair type, pregnancy, blood type, vitamin (e.g., potassium, iron, calcium, vitamin D, vitamin B, etc.) level, cholesterol level, glucose level, sodium level, skin conditions, hair conditions, allergies, sensitivities, pigmentation, and/or the like.

The characteristics may also include indirect user characteristics that are related to the user, but not direct features of the user. Indirect user characteristics identify features of the environment or context of the user. Examples of indirect user characteristics include, but are not limited to, geographical location, humidity, water characteristics (e.g., hardness, minerals within the water, water source, etc.), weather, time of year, environmental temperature, and/or the like. The user characteristics may also include user preferences. Examples of user preferences include, but are not limited to, scent preferences, product delivery preferences (e.g., gel, foam, cream, gloss, roll-on, powder, edible, chewable, etc.), color preferences, product size, and/or the like.

Receipt of the user input may include the user providing input to the graphical user interface. The graphical user interface may display one or more questions or queries to the user to learn characteristics of the user. The one or more queries may be presented as single queries with a response to the query resulting in the presentation of another query. The queries may also be presented as a form where the user tabs or moves between input fields to provide responses. The queries may also be provided as a combination of a form having queries and sets of queries being presented at one time with a response to the set of queries resulting in the presentation of another set of queries.

The user may also provide input outside of answering queries provided by the graphical user interface, for example, by searching for products, filtering products based upon specific criteria or characteristics, and/or the like. Thus, the system can extrapolate user characteristics based upon other input provided by the user. In the case that the characteristic is extrapolated from other inputs, the system may, but does not have to, request confirmation or validation from the user of the extrapolated user characteristic.

User input to the graphical user interface may also include the provision of one or more images of the user. The images may include still images, dynamic or video images, a combination thereof, multiple images, and/or the like. The images may also include images captured using a device other than a camera, for example, x-rays, sonograms, infrared, non-visible light images, and/or the like. The one or more images may be used to validate other user input provided by the user. For example, the user may identify a characteristic and the image may be used to verify or validate that characteristic. Using the skin care example, the user may identify an eye color, skin type, pigmentation amount, and skin condition. An image of the user can then be provided and used to verify all of these inputs provided by the user. Alternatively, or additionally, the image can be used to identify some of the characteristics of the user instead of having the user manually provide the characteristics.

To utilize the image to validate or identify characteristics, the system may use one or more image analysis techniques to analyze the image and extract features included within the image. The image analysis may also include comparing features to databases or secondary sources to classify and identify different features and or characteristics of the user. For example, the system may extract an area of the skin of the user that corresponds to a skin condition and analyze the skin condition against a database or secondary source to identify the specific skin condition.

After the user has provided input identifying at least one characteristic, the product scoring system may generate a profile for the user populated with the user characteristics. The profile may be editable by the user and may also be updated as a user interfaces with the product scoring software application. The profile may also be updated as a user utilizes different products and/or provides ratings for different products. The profile may also contain other information about the user in addition to user characteristics. One type of information may relate to products the user has already tried, has purchased, currently owns, and/or the like. The user characteristics and/or user profile may be stored in a user profile dataset.

The user may take an image of a product that the user currently has. The image can be analyzed by the system to identify the product, for example, using image analysis techniques, optical character recognition techniques, and/or the like. Identifying the product may include identifying a brand of the product, the name of the product, a manufacturer or distributor of the product, and/or any other identifying information. The system may also keep track of products that the user searches for or views either within the product scoring software application or through other Internet searches, or in the case of augmented reality, that the user views within the physical world. Since the user may simply glance over products, the system may use a timer and associated time threshold before identifying a product as being viewed by the user. In other words, the user may have to look at a product for a predetermined time before the product will be identified as a product viewed by the user. Additionally, or alternatively, the system may only identify a product as viewed if the user performs an action on the product in addition to looking at the product, for example, interacting with the product, viewing additional details about the product, and/or the like.

In addition to the products, the user may provide ratings for each of the products tried, purchased, owned, viewed, and/or the like, by the user. The rating may be provided in many different forms, for example, on a 0-100 rating scale, as a number of stars, using a sliding scale, selecting a point on a ratings graph, and/or the like. The rating may be an overall rating, a set of ratings each corresponding to a different feature or attribute of the product, a combination thereof, and/or the like. Different features or attributes of the product that may be rated include, but are not limited to, user preference attributes (e.g., scent, color, product delivery type, product size, etc.), an overall satisfaction with the product, product condition effectiveness (i.e., how well the product performs a desired function or addresses a target condition), how well the product responded to the user based upon the user characteristics, and/or the like. The rating may also include text from the user providing any additional comments the user has regarding the product. Any text can be analyzed by the product scoring system using one or more text analysis techniques, for example, entity extraction, semantic analysis, syntactic analysis, parts-of-speech analysis, and/or the like. The products of the user and associated ratings may be stored in a user product dataset.

Once the product is identified, the system may identify ingredients contained within the product. Identifying the ingredients may include accessing a datastore or secondary information source to search the product using one or more pieces of product identification information and retrieving an ingredient listing corresponding to the product. It should be noted that the ingredient listing may only be a partial ingredient listing. Ingredient listings may periodically be updated as new ingredients for the products are identified, for example, to update partial ingredient listings, as ingredients change for products, and/or the like. Alternatively, or additionally, the image captured by the user may include an ingredient listing that product scoring system can utilize in generating or identifying ingredients contained within the product.

The system can also identify other information or attributes of the product either from the image or through a search of the product. The other information may include information or attributes of the product other than an ingredient listing. Example product attributes include, but are not limited to, scent, product size, product delivery types, color, and/or the like. The product ingredients and product attributes may be stored in a product dataset.

Within the datastore or secondary sources, information regarding ingredients may be accessible. This information may not be related to a specific product, but may instead identify attributes or characteristics of particular ingredients that could be included in different products. For example, the ingredient characteristics may identify how an ingredient reacts to certain environmental factors or characteristics, how ingredients interact with other ingredients, conditions ingredients are effective for treating or addressing, relationships between ingredients and user characteristics, and/or the like.

The system may extrapolate the ratings of ingredients from the ratings of the products provided by the user. In other words, the product scoring system attempts to assign ratings to individual ingredients from the product ratings. In order to make this extrapolation, the system identifies ingredients that are similar between rated products. Essentially, the product scoring system is attempting to identify ingredients that may be factors or contributors to a particular product rating. Having a plurality of rated products that have combinations of ingredients included in another product can allow the system to start to determine which ingredients are contributors to the rating and then attribute the ratings to different ingredients.

The system may also assign ingredients of the product to different attributes of the product. Ratings that may be assigned to these attributes may then be analyzed to extrapolate ratings for the ingredients. For example, if ingredients A, B, and C are responsible for a scent of the product and the user rates the scent highly, the system may identify other products having ingredients A, B, and/or C and identify the rating the user provided for the scent attribute of the products. Upon identifying multiple products that have combinations of the ingredients, the system can start to attribute product ratings to ingredients and thereby assign a rating to the ingredient.

Alternatively, or additionally, the system may access product or ingredient ratings from other sources, for example, other users. For example, in the event that the user has not rated a product having a particular ingredient, the system cannot specifically attribute a rating to a particular ingredient, the user has not rated a particular product or class of products, the user has not rated enough products and/or ingredients, and/or the like, the system may access other rating sources. One rating source might be crowd-sourced ratings. Another rating source might be product page ratings. Another rating source might be social media sites. These are merely example rating sources and other rating sources are contemplated and possible. In the event that product ratings are accessed, the system may extrapolate ingredient ratings in a similar manner as previously discussed.

In order to make the product score as unique to the user as possible, the system may attempt to classify the users providing the ratings into groups based upon user characteristics. The system may then utilize the ratings that correspond to the group of users having the same or similar characteristic to the user. Similarity may be identified using one or more similarity measurement techniques. Since it may be difficult finding users that have all the same user characteristics as the user, the system may identify those user characteristics that are pertinent to the desired function and/or target product type. For example, if the user is searching for a medication to address a foot issue, the color of the user's hair may not be pertinent.

Additionally, or alternatively, user characteristics can be prioritized or weighted when determining a similarity between the user and other users. The prioritization and/or weightings may be default, set by a user, learned through a machine-learning model, and/or the like. Additionally, or alternatively, particular users may be given a higher weighting than other users, for example, based upon a number of ratings, the types of ratings, rating subsets that more closely correspond to a target function or condition of the user, and/or the like. The ingredient characteristics and ingredient ratings may be stored within an ingredient characteristic dataset.

It should be noted that additional information may be identified, captured, obtained, or stored within one or more datasets that have been described or other datasets. In other words, other information and/or datasets are possible and contemplated. The datasets may also be tuned for a particular application. For example, in a skin care application the ingredient characteristic dataset may be tuned to skin care information, whereas in a hair care application the ingredient characteristic dataset may be tuned to hair care information.

The datasets that are generated from the information can be utilized by the system for correlating ingredients to ratings, extrapolating ratings to particular ingredients, generating the product scores, and/or the like, all of which are discussed in further detail herein. The datasets, in addition to other input sets, may be utilized by one or more machine-learning models in performing any of the identified functions of the system. Other input sets may include secondary information sources, social media applications, product literature, Internet searches, and/or the like.

A machine-learning model, which may be a neural network, decision tree and/or forest, classifiers, random tree forest or classifier, a combination thereof, a combination of machine-learning models, and/or the like, may be utilized in performing one or more acts of the described system. For example, one or more machine-learning models can be used to obtain data for at least one product, to correlate at least one ingredient to a rating of the ingredient, to generate a rating for an ingredient by extrapolating ratings for other products, to generate the product score and/or a portion of the product score, and/or the like. It should be understood that while the terminology may refer to a single machine-learning model, multiple machine-learning models can be utilized in performing one or more functions of the product scoring system. The machine-learning model may include a plurality of layers, including input, output, hidden, a combination thereof, and/or the like, layers. The machine-learning model is very complex and utilizes complicated mathematical computations. Due to the complexity of the machine-learning model, it would be impossible to perform the analysis as performed by the model in the human mind.

Additionally, the machine-learning model is trained to make predictions on data that has been previously unseen by the model. To make these predictions, the model includes very complicated mathematical computations that would not be performed in the human mind. Rather, the use of a computer and processor, and, possibly a computer and processor that is specific and tuned to the machine-learning model, allows for performing these complex computations, particularly with a speed that allows for performing the complex processing found in and required by the machine-learning model in a time frame that facilitates the use of the machine-learning model for making the predictions. This speed is not possible with a human or even a group of humans. Thus, a human or even a group of humans, even using pen and paper, could not perform the analysis performed by the machine-learning model in a manner that would actually result in making the predictions provided by the machine-learning model on the large amount of data that is received by the product scoring software application in a length of time that would make the product scoring software application function as intended.

The machine-learning model may be trained using a training dataset having annotated training data. Annotated training data includes data that the model may make a prediction upon where the data is annotated with the correct prediction. The machine-learning model can learn from the training dataset how data should be classified or the predictions that should be made with respect to particular data. As predictions are made upon non-annotated data, feedback may be provided. Feedback may be provided in the form of a user making a correction, a user providing input regarding the prediction, predictions from other models regarding the same data, and/or the like. The feedback can be automatically ingested by the model to further train the model, thereby making the model more accurate over time. It should be noted that the model can monitor the predictions made by the model to identify the feedback so that a user does not have manually provide the feedback to the model. Thus, while the model may initially be trained with a training dataset, the model can continually be trained as it is deployed using predictions and feedback regarding the predictions.

It should be noted that while the analyses performed by the machine-learning models are similar across different users, the outputs provided by the machine-learning models are unique to each user because the inputs provided to the machine-learning model are unique to each user. Additionally, different machine-learning models may be utilized to perform different analyses within the system with multiple analyses being able to be performed using one or more machine-learning models.

At 302, the product scoring software application obtains data for at least one product viewable by the user. A product viewable by the user means that the product is within a viewing field of the user. For example, in the event that the user is viewing products on the Internet, a viewable product may be a product that is presented on the webpage that the user is currently viewing or could be viewing. As another example, in the event that the user is using augmented reality and viewing physical products, a product viewable to the user may include any product that is within the field of view of the user or augmented reality system.

As could be understood, it would be data intensive to collect data for every possible product that is viewable by the user, particularly because the viewable products can easily and quickly change. Accordingly, the system may only obtain data for a viewable product if the user actually looks at the product, views the product for a predetermined length of time, interacts with a product (e.g., picks up the physical product, access a product webpage, reviews ratings for a product, etc.), and/or the like. Thus, the product scoring system may employ gaze tracking techniques and components to track and monitor the gaze of the user and determine what the user is looking at. The system may also use movement tracking techniques and components to monitor and track movement of the user to determine if a user is interacting with a physical product. The criteria that cause the system to obtain data for a product may be default criteria, set by a user, and/or the like.

The data that is obtained for a viewable product may be any data corresponding to the product, for example, manufacturer, brand, distributor, name, and/or the like. The data may include at least one ingredient of the viewable product. The ingredient can be identified in a similar manner as previously discussed with respect to identifying the ingredients from the user products. The data that is obtained for a viewable product may not be provided to the user. Rather, the data may be obtained in the background and used by the product scoring system. Alternatively, or additionally, the user may be provided with the data or a subset of the data that is obtained for the product.

Obtaining the data may be responsive to a user conducting a query for a particular product. The user may provide search criteria to conduct a search query for at least one product. The search criteria may be provided within the software application as a query input. The query input may be provided as text input, image input, audio input, video input, neural input, and/or the like. Responsive to conducting the search using the search criteria, the system may identify those products returned in response to the conducted search query as viewable products and may, therefore, obtain data for those products returned in response to the conducted search query. The user may also perform search queries for products outside the product scoring software application, for example, using an Internet search engine, on a social media site, and/or the like, the product scoring software application may employ one or more techniques to access these searches, resulting products, and interactions by the user with the products, to incorporate the information within the software application. For example, the system may employ application programming interfaces (APIs), information mining techniques, and/or the like, to capture the user interactions outside of the product scoring software application.

At 303, the product scoring system determines if the ingredient(s) of the viewable product can be correlated to a rating of the ingredient(s). Correlating ratings to the ingredient(s) of the viewable product includes accessing the ingredient characteristic dataset to identify if an ingredient of the product is included in the dataset. If the ingredient is included, the system may identify what rating is assigned to that ingredient within the dataset. This rating can then be assigned to the ingredient of the viewable product. This process can continue for all ingredients within the viewable product.

Ideally, the rating of the ingredients will come from ratings provided by the user. However, as previously noted, the system may not have unique user ratings for each possible ingredient. Accordingly, the system may use the ingredient ratings that are for the user and may also use ingredient ratings from other users having similar characteristics to the user. These ratings were previously stored in the ingredient characteristic dataset. When correlating a rating to the ingredient within the viewable product, the system may prioritize the ratings given by the user over ratings provided by other users. In other words, in the event that the dataset includes a rating by the user, this rating may be selected over ratings provided by other users. The system may also weight the ratings given by the user higher than ratings given by other users, but still use both sets of ratings. Additionally, a combination of rating correlation techniques may be utilized. For example, for one ingredient, the system may only use the user provided ratings, but for another ingredient, the system may use both user-provided ratings and other user ratings.

If the product scoring system cannot correlate an ingredient to a rating at 303, the product scoring system may ignore the ingredient at 305. This may occur if the user has no ratings for this ingredient and if other user ratings also do not rate this ingredient. This may also occur if an ingredient is identified as not being an important ingredient. In other words, if the system determines that an ingredient has no effect on any of the desired functions or user preferences, the system may choose to ignore the ingredient and not correlate a rating to the ingredient. There may be other situations where an ingredient of the viewable product is not assigned a rating.

If, on the other hand, the product scoring system can correlate an ingredient to a rating at 303, the product scoring system may assign the rating to the ingredient. The system may generate a product score for the viewable product at 304 using the ratings of all the rated ingredients that are included in the product. There may be some cases where some rated ingredients are not utilized to generate the product score. There may be some criteria that causes a rated ingredient to be excluded when generating the product score. For example, if an ingredient has little effect on the performance of the product, does not affect a user preference, and/or the like, the ingredient may be excluded when generating the product score for the viewable product.

A process similar to the ingredient rating correlation may be performed for other data of the viewable product that is not an ingredient, for example, user preference attributes (e.g., scent, color, product delivery type, etc.), environmental attributes, and/or the like. All of the ratings can be aggregated when generating the product score for the viewable product. When generating the product score, the system, as previously mentioned, may utilize one or more machine-learning models in order to make the product score unique to the user. The output of the machine-learning model is unique to the user because the machine-learning model utilizes datasets that are unique to the user because they are generated using information provided by the user.

The product score represents a compatibility of the product with the user. In other words, based upon the user characteristics, product ingredients and ratings, and other inputs, the product scoring system determines if the product will perform the function desired by the user and if the product will complement and be liked by the user. Thus, the generated product score is unique to the user, meaning that one user may receive one product score for a viewable product, whereas another user, even one having similar characteristics, may receive a different product score for the same viewable product. To determine the compatibility the system takes into account not only ingredients, but other factors, for example, the user preferences, environmental conditions, and/or the like. Thus, the resulting product score may indicate that the product is not compatible with the user at all, that the product is completely compatible with the user, or anywhere in-between.

The product scoring may also be performed in view of one or more user preferences provided when the user searched for a particular product or that the user set within the system as applying to product score generation. For example, if the user provides filtering input or particular search criteria that corresponds to a particular product attribute, the ingredient ratings or other information ratings may be weighted higher than other ratings when generating the product score. As another example, the user may set user preferences within the system that indicate certain factors, like user preferences, environmental conditions, product attributes, and/or the like, should be prioritized or weighted higher than other factors.

Once the product scoring software application generates a product score for the at least one product, the product score can be output to the user. Outputting the product score may include providing a visual representation of the product score. Example visual representations include, but are not limited to, bar indicators, sliding scales, arrow indicators, a numeric output, a graphical icon, color indicators, and/or the like. Additionally, the product score may be represented in different forms and/or scales. For example, the product score may be represented on a 0-100 scale, as a set of stars or other visual icons, a 0-10 scale, as particular colors, and/or the like.

The product scoring software application may also cause additional actions to occur in addition to generating a product score. For example, the system may cause a product to be ordered based upon the product score. The user may set some criteria that may cause the system to automatically order a product. For example, the user may identify that if a product fulfills a certain number of search criteria and has a product score above a predetermined threshold, the system should automatically order the product. In the event that the system cannot find a product that is compatible with the user or, in other words, a product that does not have a product score above a particular threshold, the system may provide a notification to another person, for example, the product scoring software creator. The creator may then utilize this information to find a product for the user or create a custom product for the user.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on a single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through satellite connection, through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, the method comprising:
receiving, at a product scoring software application, user input identifying at least one characteristic corresponding to a user;
obtaining, at the product scoring software application, data for at least one product viewable by the user, wherein the data comprises at least one ingredient of the at least one product;
correlating, using the product scoring software application, the at least one ingredient to a rating of the at least one ingredient, wherein the rating is selected in view of the at least one characteristic corresponding to the user; and
generating, using the product recommendation software application, a product score for the at least one product in view of the correlating and unique to the user.

2. The method of claim 1, comprising receiving a query input identifying search criteria to be used for conducting a search query for at least one product and wherein the obtaining is responsive to conducting the search query using the query input.

3. The method of claim 1, wherein the correlating comprises accessing a database comprising a listing of ingredients and ratings corresponding to each of at least a subset of the listing of ingredients.

4. The method of claim 1, wherein the rating is based upon a product rating provided by the user for a product having the at least one ingredient.

5. The method of claim 4, wherein the product having the at least one ingredient comprises a product other than the at least one product and wherein the rating for the at least one ingredient is extrapolated from product ratings provided by the user.

6. The method of claim 1, wherein the receiving user input comprises receiving an image of the user.

7. The method of claim 1, wherein the receiving user input comprises providing queries to the user and receiving input responsive to the queries and generating a profile of the user based upon the input responsive to the queries.

8. The method of claim 1, wherein the generating comprises utilizing a machine-learning model.

9. The method of claim 1, wherein the product score represents a compatibility of the at least one product with the user.

10. The method of claim 1, wherein the generating comprises generating the product score in view of user preferences.

11. A system, the system comprising:
a processor;
a memory device that stores instructions that, when executed by the processor, causes the information handling device to:
receive, at a product scoring software application, user input identifying at least one characteristic corresponding to a user;
obtain, at the product scoring software application, data for at least one product viewable by the user, wherein the data comprises at least one ingredient of the at least one product;
correlate, using the product scoring software application, the at least one ingredient to a rating of the at least one ingredient, wherein the rating is selected in view of the at least one characteristic corresponding to the user; and
generate, using the product recommendation software application, a product score for the at least one product in view of the correlating and unique to the user.

12. The system of claim 11, comprising receiving a query input identifying search criteria to be used for conducting a search query for at least one product and wherein the obtaining is responsive to conducting the search query using the query input.

13. The system of claim 11, wherein the correlating comprises accessing a database comprising a listing of ingredients and ratings corresponding to each of at least a subset of the listing of ingredients.

14. The system of claim 11, wherein the rating is based upon a product rating provided by the user for a product having the at least one ingredient.

15. The system of claim 14, wherein the product having the at least one ingredient comprises a product other than the at least one product and wherein the rating for the at least one ingredient is extrapolated from product ratings provided by the user.

16. The system of claim 11, wherein the receiving user input comprises receiving an image of the user.

17. The system of claim 11, wherein the receiving user input comprises providing queries to the user and receiving input responsive to the queries and generating a profile of the user based upon the input responsive to the queries.

18. The system of claim 11, wherein the generating comprises utilizing a machine-learning model.

19. The system of claim 11, wherein the product score represents a compatibility of the at least one product with the user.

20. A product, the product comprising:
a computer-readable storage device that stores executable code that, when executed by a processor, causes the product to:
receive, at a product scoring software application, user input identifying at least one characteristic corresponding to a user;
obtain, at the product scoring software application, data for at least one product viewable by the user, wherein the data comprises at least one ingredient of the at least one product;
correlate, using the product scoring software application, the at least one ingredient to a rating of the at least one ingredient, wherein the rating is selected in view of the at least one characteristic corresponding to the user; and
generate, using the product recommendation software application, a product score for the at least one product in view of the correlating and unique to the user.
